(19) United States
(12) Patent Application Publication
(10) Pub. No.: US 2015/0215568 A1
(43) Pub. Date: Jul. 30, 2015

(54) CONTROLLER, CONTROL METHOD, IMAGE PROJECTION SYSTEM, AND IMAGE PROCESSOR

(71) Applicant: KABUSHIKI KAISHA TOSHIBA, Tokyo (JP)

(72) Inventors: Mikiko KARASAWA, Tokyo (JP); Masahiro BABA, Yokohama (JP); Yasutoyo TAKEYAMA, Kawasaki (JP); Hisashi KOBIKI, Kawasaki (JP); Wataru WATANABE, Kawasaki (JP)

(21) Appl. No.: 14/603,999

(22) Filed: Jan. 23, 2015

(30) Foreign Application Priority Data
Jan. 24, 2014 (JP) 2014-011029

(51) Int. Cl. H04N 5/74

(52) U.S. Cl. CPC H04N 5/7416

(57) ABSTRACT

According to one embodiment, a controller includes: an analyzer; a determiner; a projection image generator. The analyzer analyzes an environment of a projection surface on which an image is projected, based on a capture image obtained by capturing a region including at least part of the projection surface. The determiner determines a parameter for controlling illumination light illuminating the region based on information regarding the analyzed environment. The projection image generator generates a projection image projected on the region based on the information regarding the environment and acquired image data.

### CROSS-REFERENCE TO RELATED APPLICATIONS

This application is based upon and claims the benefit of priority from Japanese Patent Application No. 2014-011029, filed on Jan. 24, 2014; the entire contents of which are incorporated herein by reference.

### FIELD

Embodiments described herein relate generally to a controller, a control method, an image projection system, and an image processor.

### BACKGROUND

In stores and exhibitions, for instance, a digital signage for projecting an image using a projector is utilized for the purpose of attracting customers and promoting sales. The projected image includes e.g. a still image for announcing events of the store and a promotion video of merchandise.

Here, if illumination light or an image is projected by the projector irrespective of the environment around the region on which the image is projected, the viewability of the projected image may be decreased e.g. under the existing illumination of the store. There is demand for projecting an image with high viewability and producing a display for promoting buyer motivation depending on the characteristics of the existing illumination of the store and the characteristics of various exhibits.

30

### BRIEF DESCRIPTION OF THE DRAWINGS

FIG. 1 is a block diagram showing a controller and an image projection system according to an embodiment of the invention;

FIG. 2 is a block diagram showing a specific example of the controller and the image projection system according to this embodiment;

FIG. 3 is a block diagram showing an alternative specific example of the controller and the image projection system according to this embodiment;

FIG. 4 is a block diagram showing a further alternative specific example of the controller and the image projection system according to this embodiment;

FIG. 5 is a flow chart showing the control method of this specific example;

FIG. 6 is a block diagram showing a further alternative specific example of the controller and the image projection system according to this embodiment;

FIG. 7 is a block diagram showing a further alternative specific example of the controller and the image projection system according to this embodiment;

FIG. 8 is a block diagram showing a further alternative specific example of the controller and the image projection system according to this embodiment;

FIG. 9 is a block diagram showing a further alternative specific example of the controller and the image projection system according to this embodiment;

FIG. 10 is a block diagram showing a further alternative specific example of the controller and the image projection system according to this embodiment;

FIG. 11 is a flow chart showing the control method of the specific example shown in FIG. 10;

FIG. 12 is a block diagram showing a further alternative specific example of the controller and the image projection system according to this embodiment; and

FIG. 13 is a block diagram showing a further alternative specific example of the controller and the image projection system according to this embodiment.

### DETAILED DESCRIPTION

In general, according to one embodiment, a controller includes: an analyzer; a determiner; a projection image generator. The analyzer analyzes an environment of a projection surface on which an image is projected, based on a capture image obtained by capturing a region including at least part of the projection surface. The determiner determines a parameter for controlling illumination light illuminating the region based on information regarding the analyzed environment. The projection image generator generates a projection image projected on the region based on the information regarding the environment and acquired image data.

Embodiments of the invention will now be described with reference to the drawings. In the drawings, similar components are labeled with like reference numerals, and the detailed description thereof is omitted appropriately.

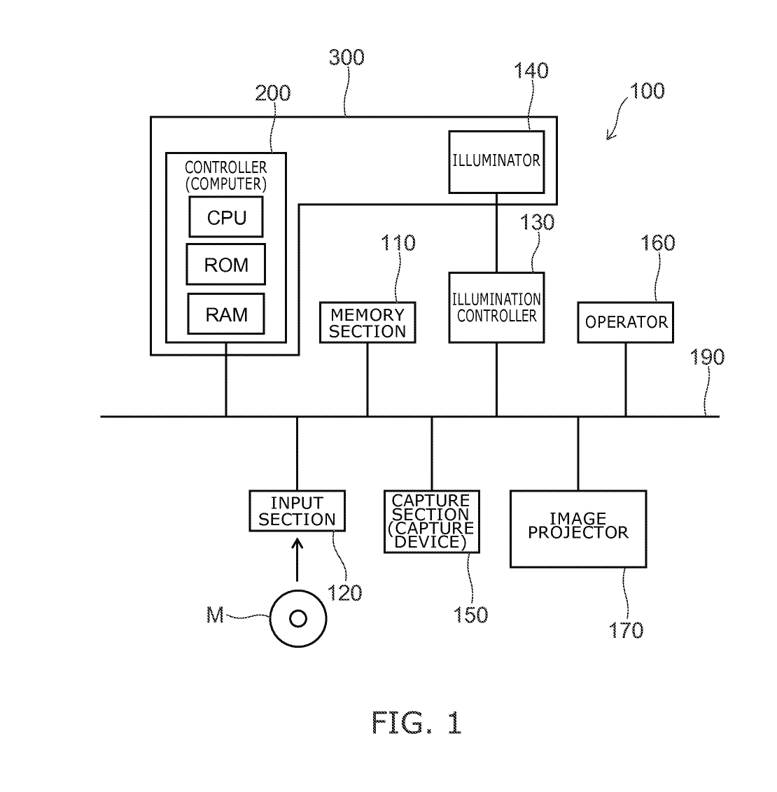

FIG. 1 is a block diagram showing a controller and an image projection system according to an embodiment of the invention.

The block diagram shown in FIG. 1 shows an example of the main configuration of the controller and an example of the main configuration of the image projection system according to this embodiment. The block diagram is not necessarily in agreement with the configuration of actual program modules.

The image projection system 100 shown in FIG. 1 includes a controller (computer) 200, a memory section 110, an input section 120, an illumination controller 130, an illuminator 140, a capture section (capture device) 150, an operator 160, and an image projector 170. An image processor 300 includes the controller 200 and the illuminator 140.

The controller 200, the memory section 110, the input section 120, the illumination controller 130, the illuminator 140, the capture section 150, the operator 160, and the image projector 170 are connected to each other through a bus 190.

The controller 200 may be an external device different from the image projection system 100, or may be a device included in the image projection system 100. The illuminator 140 may be an external device different from the image projection system 100, or may be a device included in the image projection system 100. The capture section 150 may be an external device different from the image projection system 100, or may be a device included in the image projection system 100. The hardware configuration shown in FIG. 1 is only illustrative. Part or all of the controller 200 according to the embodiment may be realized as an integrated circuit such as LSI (large scale integration) or an IC (integrated circuit) chip set. The functional blocks may be individually configured as processors. Alternatively, some or all of the functional blocks may be integrated into a processor. The integrated circuit is not limited to LSI, but may be configured as a dedicated circuit or in a general-purpose processor. The embodiment illustrates a system configuration in which a plurality of devices are connected by wireline or wireless connection. However, the embodiment may be configured as one device including part or all of the system configuration.

The controller 200 includes a CPU (central processing unit), a ROM (read only memory), and a RAM (random access memory). The CPU reads a program stored in the ROM or the memory section 110 into the RAM and executes the program. Thus, the controller 200 controls various sections of the image projection system 100.

The memory section 110 is a memory device such as a hard disk drive and a flash memory. The memory section 110 stores various programs and data.

The input section 120 reads information recorded on a recording medium M. Alternatively, the input section 120 acquires a signal from an external device such as a DVD (digital versatile disc) player and a personal computer.

The illumination controller 130 transmits a control signal regarding illumination light to the illuminator.

The illuminator 140 emits illumination light having a dimming level and a toning level based on the control signal transmitted from the illumination controller 130. The illuminator 140 may be e.g. an existing illumination installed in the store.

The capture section 150 captures a region including at least part of the surface on which the image is projected (projection surface). The capture section 150 transmits the capture image data to the controller 200. The capture section 150 may be e.g. an existing camera installed in the store.

The operator 160 is e.g. a set of buttons such as a numeric keypad, a mouse, or a touch pad superposed on the display. The operator 160 transmits an operation signal based on the content of the operation by a user to the controller 200.

The image projector 170 projects an image based on a signal transmitted from the controller 200. The image may be a still image or a moving image.

The program of this embodiment may be recorded on the computer-readable recording medium M. The recording medium M may be a memory device such as a server connected to a network. The program of this embodiment may be delivered through a network.

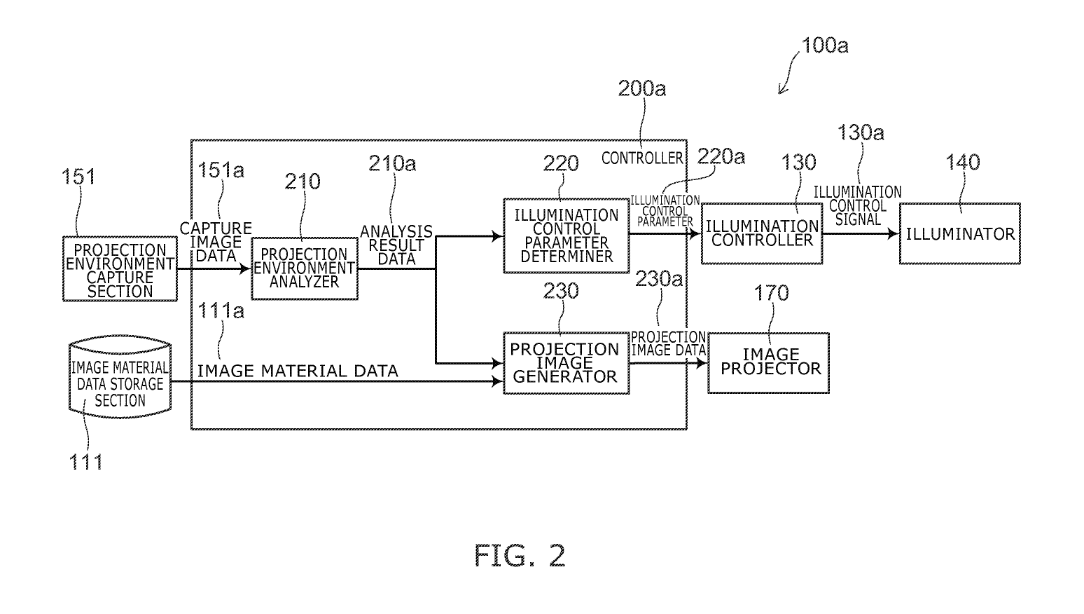

FIG. 2 is a block diagram showing a specific example of the controller and the image projection system according to this embodiment.

In the following, the specific examples shown in FIGS. 2 to 8 are described with reference to an example in which information is not projected on the region (article region) where an article (object article) exists.

The image projection system 100a according to the specific example shown in FIG. 2 includes a controller 200a, an image material data storage section 111, an illumination controller 130, an illuminator 140, a projection environment capture section 151, and an image projector 170. The image material data storage section 111 is included in the memory section 110 described above with reference to FIG. 1. The projection environment capture section 151 is included in the capture section 150 described above with reference to FIG. 1. The controller 200a includes a projection environment analyzer (first analyzer) 210, an illumination control parameter determiner 220, and a projection image generator 230.

The image material data storage section 111 stores material data (image material data) 111a of the image projected by the image projector 170. The projection environment capture section 151 captures a region including at least part of the projection surface. The projection environment capture section 151 transmits the captured image data (capture image data) 151a to the projection environment analyzer 210.

The projection environment analyzer 210 analyzes the environment of the projection surface based on the capture image data 151a transmitted from the projection environment capture section 151. The projection environment analyzer 210 transmits the analysis result data 210a to the illumination control parameter determiner 220 and the projection image generator 230. The illumination control parameter determiner 220 determines an illumination control parameter 220a based on the analysis result data 210a transmitted from the projection environment analyzer 210. The illumination control parameter 220a is a parameter for controlling illumination light emitted by the illuminator 140. The illumination control parameter determiner 220 transmits the illumination control parameter 220a to the illumination controller 130. The projection image generator 230 generates an image (projection image) projected from the image projector 170. This is based on the analysis result data 210a transmitted from the projection environment analyzer 210 and the image material data 111a acquired from the image material data storage section 111. The projection image generator 230 transmits the projection image data 230a to the image projector 170.

The illumination controller 130 transmits an illumination control signal 130a to the illuminator 140. The illumination control signal 130a is a signal for controlling the illuminator 140 based on the illumination control parameter 220a transmitted from the illumination control parameter determiner 220. The illuminator 140 emits illumination light having a dimming level and a toning level based on the illumination control signal 130a transmitted from the illumination controller 130. Thus, the illuminator 140 illuminates a region including at least part of the projection surface. The image projector 170 projects an image regarding the projection image data 230a transmitted from the projection image generator 230 on the projection surface.

The details of the operation (control method) of the controller and the image projection system according to this embodiment will be described later.

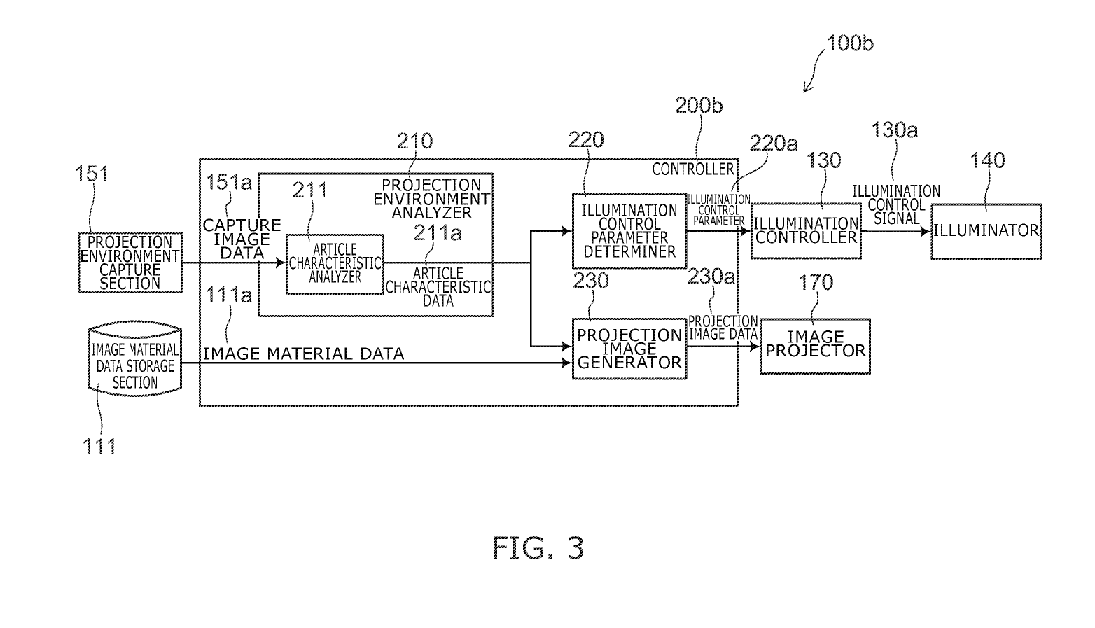

FIG. 3 is a block diagram showing an alternative specific example of the controller and the image projection system according to this embodiment.

In the image projection system 100b according to the specific example shown in FIG. 3, the projection environment analyzer 210 of the controller 200b includes an article characteristic analyzer (second analyzer) 211. The article characteristic analyzer 211 may be undistinguished constitutionally from the projection environment analyzer 210. The operation of the article characteristic analyzer 211 may be performed by the projection environment analyzer 210. The article characteristic analyzer 211 analyzes the characteristic of the detected article based on the capture image data 151a transmitted from the projection environment capture section 151. In other words, the article characteristic analyzer 211 identifies the detected article based on the capture image data 151a transmitted from the projection environment capture section 151. For instance, the article characteristic analyzer 211 acquires the category of the detected article from an article database and stores the category. The categories include e.g. fresh fish, meat, fruit and vegetables, delicatessen, and bread. The rest of the configuration is as described above with reference to FIG. 2.

In this specific example, the illumination control parameter determiner 220 determines an illumination control parameter 220a based on the article characteristic data 211a transmitted from the article characteristic analyzer 211. The projection image generator 230 generates a projection image based on the article characteristic data 211a transmitted from the article characteristic analyzer 211.

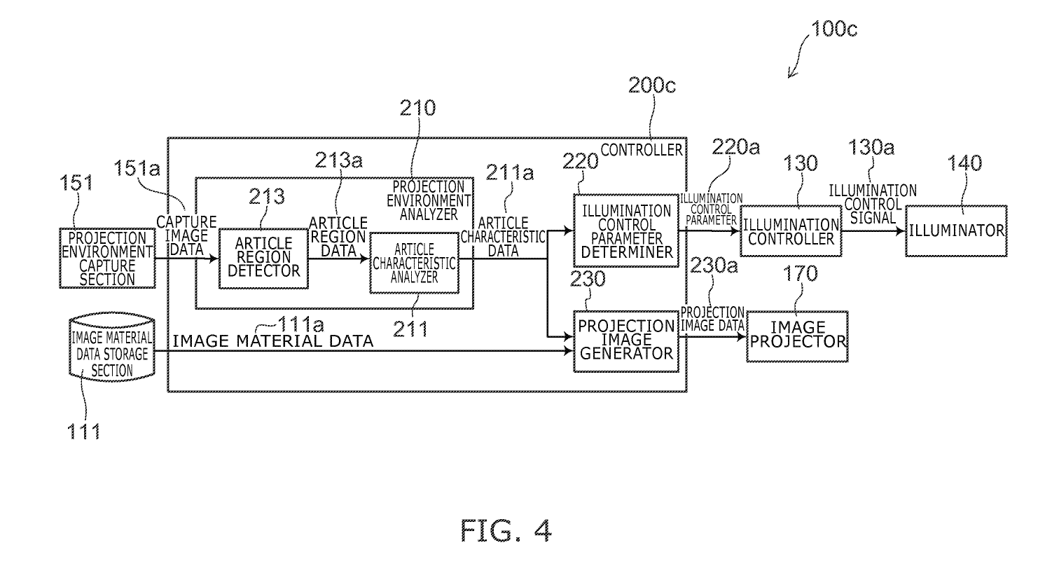

FIG. 4 is a block diagram showing a further alternative specific example of the controller and the image projection system according to this embodiment.

In the image projection system 100c according to the specific example shown in FIG. 4, the projection environment analyzer 210 of the controller 200c includes an article characteristic analyzer 211 and an article region detector (first detector) 213. The article region detector 213 detects an article captured in the capture image based on the capture image data 151a transmitted from the projection environment capture section 151 and stores the region of the article. The rest of the configuration is as described above with reference to FIGS. 2 and 3.

Here, the operation (control method) of the controller 200c and the image projection system 100c of this specific example is described with reference to the drawings.

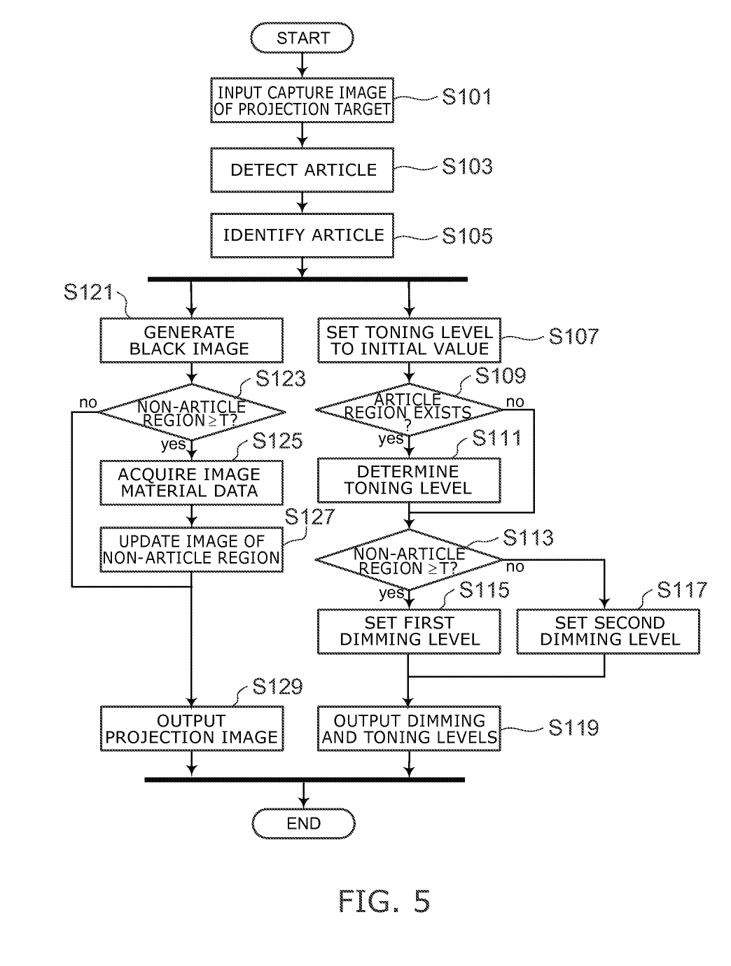

FIG. 5 is a flow chart showing the control method of this specific example.

The control method of this specific example is described with reference to the following example. The article characteristic analyzer 211 identifies an article. The image projector 170 projects a black image on the region (article region) in which the article detected by the article region detector 213 exists. The image projector 170 projects an image of the image material data 111a on the region (non-article region) other than the article region. Projecting a black image on the article region by the image projector 170 means that the article region is illuminated with only the illumination light emitted from the illuminator 140.

In the control method of this specific example, the projection image generator 230 generates one image for one image captured by the projection environment capture section 151. Furthermore, the illumination control parameter determiner 220 determines one dimming level and one toning level for one image captured by the projection environment capture section 151.

The timing of capturing a region including at least part of the projection surface by the projection environment capture section 151 may be 30 fps (frames per second). Alternatively, the timing may be e.g. once per day at the opening time of the store. In the control method of this specific example, the illumination control parameter determiner 220 determines the dimming level so that the brightness of the illumination light emitted by the illuminator 140 decreases in the case where there is a non-article region larger than a certain size. Thus, the image projector 170 can project the image of the image material data 111a while suppressing the decrease of viewability. Furthermore, the illumination control parameter determiner 220 determines the toning level so that illumination light having a color adapted to the kind of the article detected by the article characteristic analyzer 211 is emitted.

First, the projection environment capture section 151 transmits capture image data 151a to the article region detector 213 (step S101). The capture image data 151a is the data of the image capturing the projection target. The image is at least one of a moving image and a still image. In the case where the image is a moving image, one frame of the moving image is used. The image format used for processing is e.g. a bit map.

Next, the article region detector 213 detects an article captured in the capture image based on the capture image data 151a transmitted from the projection environment capture section 151 (step S103). The article region detector 213 maintains e.g. an article image database. The article region detector 213 detects an article using existing techniques such as region dividing and learning for pattern recognition, and existing identification techniques. When the article region detector 213 has detected an article, the article region detector 213 stores a region of the article (article region) in the capture image. The article region detector 213 stores the article region by e.g. the number of pixels corresponding to a continuous article region, and a map image with each pixel recording whether it constitutes the article region.

Next, the article characteristic analyzer 211 identifies the detected article based on the capture image data 151a transmitted from the projection environment capture section 151 through the article region detector 213 (step S105). For instance, the article characteristic analyzer 211 acquires the category of the detected article from an article database and stores the category. The categories include e.g. fresh fish, meat, fruit and vegetables, delicatessen, and bread.

Next, the illumination control parameter determiner 220 sets the toning level to an initial value (step S107). The initial value is e.g. generally at the same toning level as the existing store illumination. The initial value is e.g. a light bulb color (warm white). Next, the illumination control parameter determiner 220 determines whether there is an article region based on the article region data 213a transmitted from the article region detector 213 through the article characteristic analyzer 211 (step S109). That is, the illumination control parameter determiner 220 determines whether the article region detector 213 has detected an article.

In the case where there is an article region (step S109: yes), the illumination control parameter determiner 220 determines a toning level (step S111). The toning level is a level such as WW (warm white), D (daylight), and CW (cool white). For instance, the illumination control parameter determiner 220 maintains a table indicating the toning level corresponding to the article category acquired by the article characteristic analyzer 211. The illumination control parameter determiner 220 determines the toning level by looking up the table. For instance, in the case where the category is meat or bread, the illumination control parameter determiner 220 determines the toning level to be WW (warm white). For instance, in the case where the category is fruit and vegetables, the illumination control parameter determiner 220 determines the toning level to be D (daylight). For instance, in the case where the category is fresh fish, the illumination control parameter determiner 220 determines the toning level to be CW (cool white).

In the case where there is no article region (step S109: no), the illumination control parameter determiner 220 determines whether the value of the non-article region is T or more without changing the toning level (step S113). That is, the illumination control parameter determiner 220 determines the toning level if there is an article region, and does not determine the toning level if there is no article region. The value T is a value representing the minimum image size at which the projection image is viewable. The value T is e.g. the number of pixels.

In the case where the value of the non-article region is T or more (step S113: yes), the illumination control parameter determiner 220 determines the dimming level to be a first dimming level (step S115). On the other hand, in the case where the value of the non-article region is not T or more (step S113: no), the illumination control parameter determiner 220 determines the dimming level to be a second dimming level (step S117). In this specific example, the second dimming level is higher than the first dimming level.

The dimming level is a value of e.g. 0% or more and 100% or less. In the case where the dimming level is 0%, the illuminator 140 turns to the state of lights out. In the case where the dimming level is 100%, the illuminator 140 emits illumination light with maximum brightness. In the case where the dimming level is higher than 0% and lower than 100%, the illuminator 140 emits illumination light with brightness of a plurality of levels between the state of lights out and the state of maximum brightness.

In this specific example, the first dimming level is 50%. The second dimming level is 100%. However, the first dimming level and the second dimming level are not limited thereto. For instance, the first dimming level may be 0% (lights out).

Next, the illumination control parameter determiner 220 transmits the determined dimming level and toning level as an illumination control parameter 220a to the illumination controller 130 (step S119). In the case where the illumination control parameter determiner 220 has determined the toning level (step S109: yes, step S111), the illumination control parameter determiner 220 transmits the toning level determined in step S111 as an illumination control parameter 220a to the illumination controller 130. In the case where the illumination control parameter determiner 220 has not determined the toning level (step S109: no), the illumination control parameter determiner 220 transmits the initial value determined in step S107 as an illumination control parameter 220a to the illumination controller 130.

The projection image generator 230 generates a projection image with all the pixels set to black (step S121).

Next, the projection image generator 230 determines whether the value of the non-article region is T or more (step S123). In the case where the value of the non-article region is T or more (step S123: yes), the projection image generator 230 acquires image material data 111a from the image material data storage section 111 (step S125). The image material data 111a includes e.g. still images and moving images. The content of the image material data 111a can be e.g. the article name, the price, a POP (point-of-purchase) advertisement carrying a catch phrase, a sales campaign advertisement announcing bargain-priced articles, and images of producers and dishes.

Here, a user may indicate the content of the image material data 111a through the operator 160 (see FIG. 1). Then, the projection image generator 230 may acquire the image material data 111a corresponding to the content from the image material data storage section 111. For instance, the user may indicate to announce bargain-priced articles through the operator 160. Then, the projection image generator 230 acquires image material data 111a including announcements of bargain-priced articles from the image material data storage section 111. Alternatively, the projection image generator 230 may acquire an image directly indicated through the operator 160 by a user.

Next, the projection image generator 230 updates a portion corresponding to the non-article region in the projection image based on the image material data 111a acquired from the image material data storage section 111 (step S127). For instance, the projection image generator 230 reduces the image material data 111a acquired from the image material data storage section 111 to the maximum size displayable within the range of the non-article region. Next, the projection image generator 230 updates the portion corresponding to the non-article region in the projection image by overwriting the portion with the information of the reduced image. Existing methods are used in determining the size and reducing the image.

Here, calibration between the position of the image projected by the image projector 170 and the position of the image captured by the projection environment capture section 151 is performed in advance by existing methods.

Next, the projection image generator 230 transmits the projection image updated in step S127 as projection image data 230a to the image projector 170 (step S129).

In the case where the value of the non-article region is not T or more (step S123: no), the projection image generator 230 ends its own processing. Then, the projection image generator 230 transmits the projection image generated in step S121 (the projection image with all the pixels set to black) as projection image data 230a to the image projector 170.

According to this specific example, on the store shelf with articles displayed thereon, an image with high viewability can be projected on the region (non-article region) other than the article region. Furthermore, the article region can be illuminated with illumination light of a color adapted to the article. That is, according to this specific example, an image with high viewability can be projected in accordance with the surrounding environment. For instance, in the case where the article is a food product, the food product can be shown so as to look delicious.

The specific examples described above with reference to FIGS. 2 and 3 also achieve a similar effect.

The article characteristic analyzer 211 may analyze color information of the detected article based on the capture image data 151a transmitted from the projection environment capture section 151 through the article region detector 213. For instance, the article characteristic analyzer 211 estimates the color of the article by the RGB values of the pixel of the article region in the capture image based on the capture image data 151a transmitted from the projection environment capture section 151. This is different from the specific example in which the article characteristic analyzer 211 recognizes the article captured in the capture image and recognizes the color of the article by looking up a database.

In the case where the article characteristic analyzer 211 analyzes color information of the article, the illumination control parameter determiner 220 is operated as follows based on the color information of the article included in the article characteristic data 211a transmitted from the article characteristic analyzer 211. For instance, when the R value of the RGB values is the largest, the illumination control parameter determiner 220 determines the toning level to be WW (warm white). For instance, when the B value of the RGB values is the largest, the illumination control parameter determiner 220 determines the toning level to be CW (cool white). For instance, when the G value of the RGB values is the largest or when at least two values of the RGB values are equal, the illumination control parameter determiner 220 determines the toning level to be D (daylight).

In this case, for instance, in the case where the article is a food product, the food product can be shown so as to look delicious in accordance with the color of the food product.

The article characteristic analyzer 211 may analyze temperature information of the detected article based on the capture image data 151a transmitted from the projection environment capture section 151 through the article region detector 213. In this case, the capture image data 151a is the data of e.g. a thermographic image which enables recognition of the temperature distribution of the environment of the projection target. The projection environment capture section 151 transmits the capture image data 151a to the projection environment analyzer 210.

In the case where the article characteristic analyzer 211 analyzes temperature information of the article, the illumination control parameter determiner 220 is operated as follows. When the average temperature of the article region in the capture image is equal to a first temperature or more, the illumination control parameter determiner 220 determines the toning level to be WW (warm white). For instance, when the average temperature of the article region in the capture image is equal to a second temperature or more and less than the first temperature, the illumination control parameter determiner 220 determines the toning level to be D (daylight). For instance, when the average temperature of the article region in the capture image is less than the second temperature, the illumination control parameter determiner 220 determines the toning level to be CW (cool white). Here, the first temperature is higher than the second temperature.

When the average temperature of the article region in the capture image is equal to the first temperature or more, the projection image generator 230 selects and acquires an image having a warm color from the image material data storage section 111. When the average temperature of the article region in the capture image is equal to the second temperature or more and less than the first temperature, the projection image generator 230 selects and acquires a projection image from the image material data storage section 111 irrespective of warm color or cold color. When the average temperature of the article region in the capture image is less than the second temperature, the projection image generator 230 selects and acquires an image having a cold color from the image material data storage section 111.

In this case, for instance, in the case where the article is a food product, the food product can be shown so as to look delicious in accordance with the temperature of the food product. Alternatively, the projection image can be changed in accordance with the temperature of the article.

The article characteristic analyzer 211 may analyze freshness information of the detected article based on the capture image data 151a transmitted from the projection environment capture section 151 through the article region detector 213. In this case, the capture image data 151a is the data of e.g. an image of an advanced multispectral camera which enables recognition of the freshness of the article. The projection environment capture section 151 transmits the capture image data 151a to the projection environment analyzer 210.

In the case where the article characteristic analyzer 211 analyzes freshness information of the article, the illumination control parameter determiner 220 is operated as follows. When the average freshness of the article region in the capture image is equal to a value F or less, the illumination control parameter determiner 220 determines the toning level to be D (daylight). When the average freshness of the article region in the capture image is higher than the value F, the illumination control parameter determiner 220 leaves the toning level to be the initial value (e.g., warm white).

When the average freshness of the article region in the capture image is equal to the value F or less, the projection image generator 230 selects and acquires an image from the image material data storage section 111. The image indicates that the detected article is highly recommended.

In this case, for instance, in the case where the article is a food product, the food product can be shown so as to look delicious by changing the illumination setting for the food product with relatively lowered freshness. Alternatively, an image for enhancing sales campaign of the food product can be projected for the food product with relatively lowered freshness.

The article characteristic analyzer 211 may analyze surface profile information of the detected article based on the capture image data 151a transmitted from the projection environment capture section 151 through the article region detector 213. In this case, the capture image data 151a is the data of e.g. a depth map of a depth camera which enables recognition of the surface profile of the article region. The projection environment capture section 151 transmits the capture image data 151a to the projection environment analyzer 210. Here, the projection environment analyzer 210 may also analyze surface profile information of the non-article region based on the capture image data 151a. Thus, the projection environment analyzer 210 may correct the distortion of the image projected on the non-article region.

In the case where the article characteristic analyzer 211 analyzes surface profile information of the article, the projection image generator 230 predistorts the projection image in the direction opposite to the surface profile based on the depth map included in the capture image data 151a. Thus, the projection image generator 230 can correct the distortion of the image due to the surface profile of the article.

In this case, a projection image with lower distortion can be generated and projected even if the surface of the article includes unevenness.

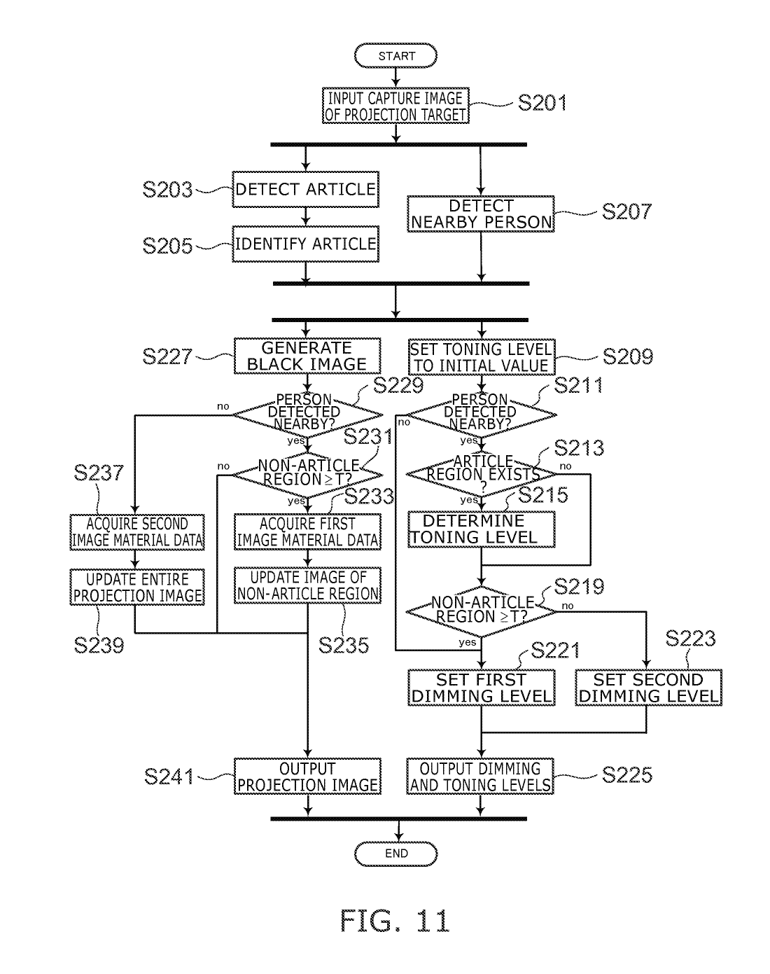

In FIG. 5, the operation of the illumination control parameter determiner 220 (steps S107-S119) is shown in synchronization with the operation of the projection image generator 230 (steps S121-S129). However, in this specific example, the operation of the illumination control parameter determiner 220 (steps S107-S119) does not need to be in synchronization with the operation of the projection image generator 230 (steps S121-S129). This also applies to the control method described later with reference to FIG. 11.

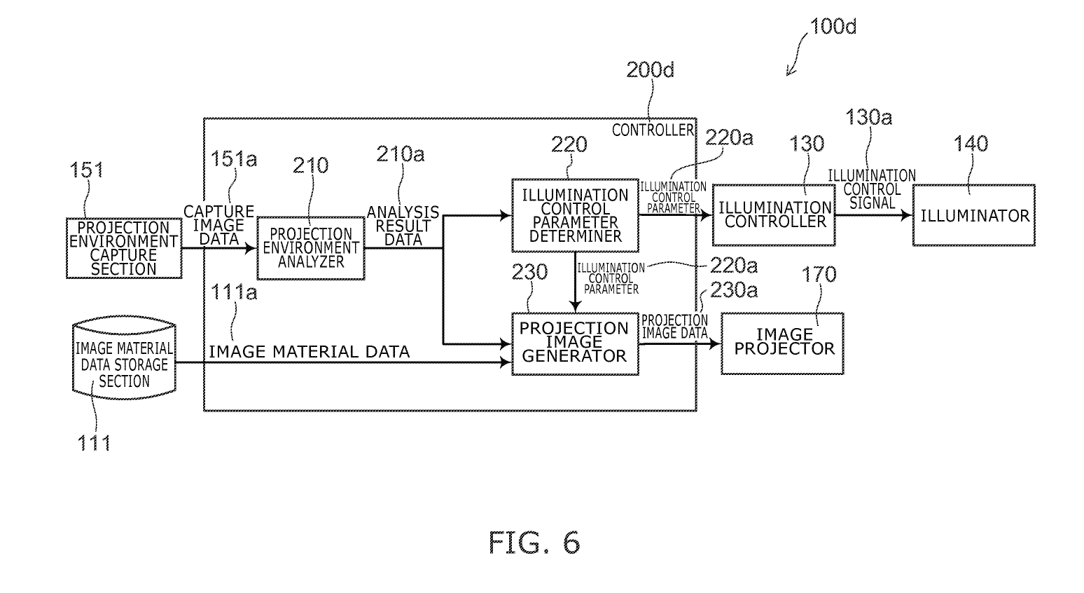

FIG. 6 is a block diagram showing a further alternative specific example of the controller and the image projection system according to this embodiment.

The image projection system 100d according to the specific example shown in FIG. 6 includes a controller 200d, an image material data storage section 111, an illumination controller 130, an illuminator 140, a projection environment capture section 151, and an image projector 170. The illumination control parameter determiner 220 of this specific example transmits the illumination control parameter 220a to the illumination controller 130 and the projection image generator 230. The rest of the configuration is as described above with reference to FIG. 2.

In this specific example, the projection image generator 230 performs color correction of the projection image based on the toning level included in the illumination control parameter 220a transmitted from the illumination control parameter determiner 220. For instance, the projection image generator 230 converts the color of the image material data 111a acquired from the image material data storage section 111 into a color enhancing the viewability of the projection image in accordance with the toning level determined by the illumination control parameter determiner 220. For instance, the projection image generator 230 includes a look-up table (LUT). The LUT records information regarding the method for converting the pixel value of each pixel of the image in accordance with the toning level transmitted from the illumination control parameter determiner 220. The projection image generator 230 reads the LUT. Thus, the projection image generator 230 performs color conversion in accordance with the toning level transmitted from the illumination control parameter determiner 220.

According to this specific example, the decrease of the viewability of the projection image can be suppressed even in the case where the setting of illumination is changed with the article.

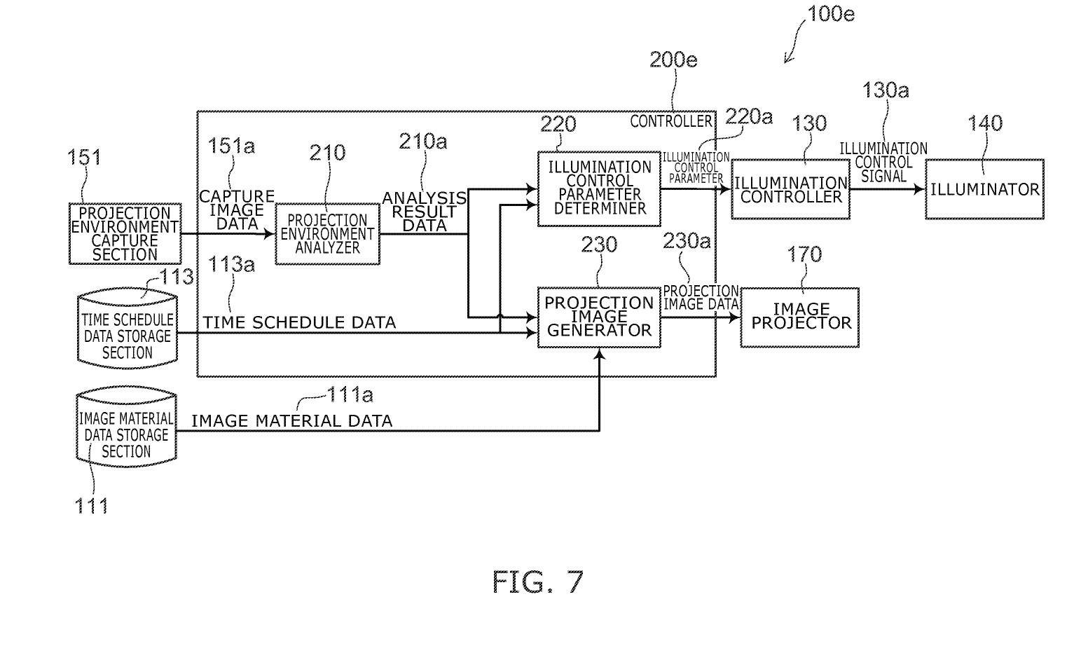

FIG. 7 is a block diagram showing a further alternative specific example of the controller and the image projection system according to this embodiment.

The image projection system 100e according to the specific example shown in FIG. 7 further includes a time schedule data storage section 113 in comparison with the image projection system 100a according to the specific example described above with reference to FIG. 2. The time schedule data storage section 113 is included in the memory section 110 described above with reference to FIG. 1. The rest of the configuration is as described above with reference to FIG. 2.

In this specific example, the illumination control parameter determiner 220 of the controller 200e performs processing based on time schedule data 113a acquired from the time schedule data storage section 113 and the analysis result data 210a transmitted from the projection environment analyzer 210. The projection image generator 230 of the controller 200e performs processing based on the time schedule data 113a and the analysis result data 210a. The time schedule data 113a is the data stored in the time schedule data storage section 113. The time schedule data 113a is the data on a schedule management system.

For instance, the time schedule data 113a indicates a schedule inputted in advance by a user (operator). Alternatively, the time schedule data 113a indicates data defining which display mode of a plurality of modes is used for control at each time. The display mode corresponds to the illumination mode or the image generation mode of the projected image.

More specifically, for instance, the illumination control parameter determiner 220 may recognize that the current time falls within the limited offer time based on the time schedule data 113a. Then, the illumination control parameter determiner 220 determines the toning level to be 0%.

For instance, the projection image generator 230 may recognize that the current time falls within the limited offer time based on the time schedule data 113a. Then, the projection image generator 230 generates an image emulating a spotlight. For instance, the image emulating a spotlight moves for each frame. The image emulating a spotlight may include information such as letters.

According to this specific example, display can be performed in accordance with the time schedule while the illumination light is operated in conjunction with the projection image.

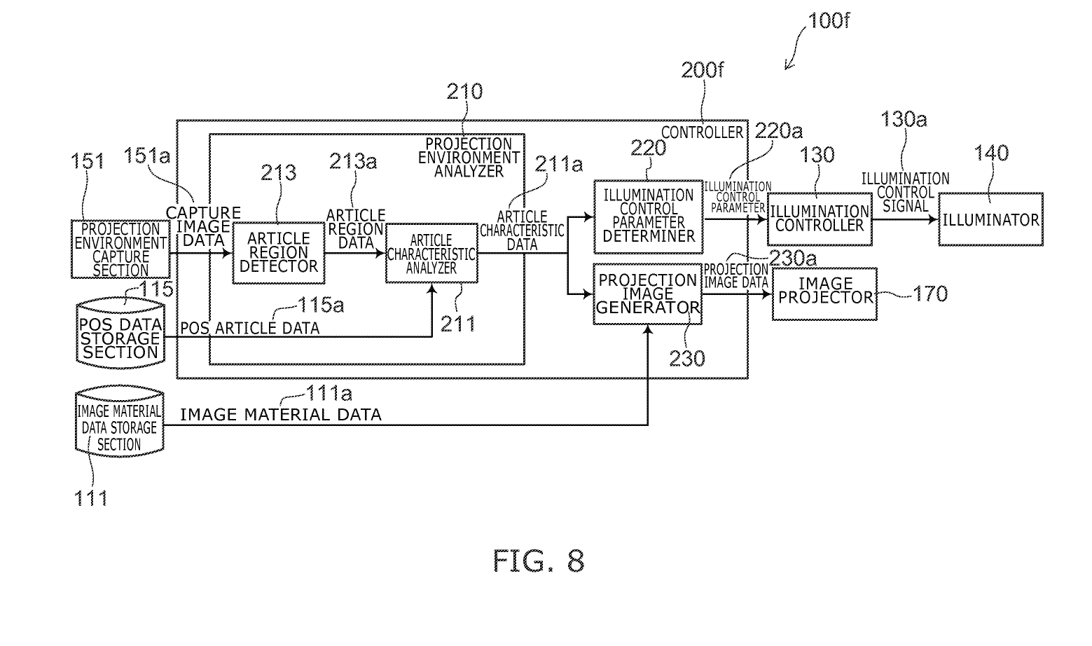

FIG. 8 is a block diagram showing a further alternative specific example of the controller and the image projection system according to this embodiment.

The image projection system 100f according to the specific example shown in FIG. 8 further includes a POS (point-of-sale) data storage section 115 in comparison with the image projection system 100c according to the specific example described above with reference to FIG. 4. The POS data storage section 115 is included in the memory section 110 described above with reference to FIG. 1. The rest of the configuration is as described above with reference to FIG. 4.

In this specific example, the article characteristic analyzer 211 of the controller 200f performs processing based on POS article data (object article data) 115a acquired from the

POS data storage section 115 and the capture image data 151a transmitted from the projection environment capture section 151 through the article region detector 213. The POS article data 115a is the data stored in the POS data storage section 115. The POS article data 115a is the data on a POS system.

For instance, the article characteristic analyzer 211 outputs, as article characteristic data 211a, the article region data 213a and the POS article data 115a acquired from the POS data storage section 115. The POS article data 115a includes information regarding e.g. the article name, the article category, the price, the number of articles in stock, and the sales status. The article characteristic analyzer 211 determines which of the articles registered in the POS data storage section 115 corresponds to the captured article (detected article) by e.g. pattern recognition. This is based on the capture image data 151a transmitted from the projection environment capture section 151 through the article region detector 213.

In the case where the captured article corresponds to none of the articles registered in the POS data storage section 115, the illumination control parameter determiner 220 transmits a predetermined illumination control parameter 220a to the illumination controller 130.

In the case where the captured article corresponds to none of the articles registered in the POS data storage section 115, the projection image generator 230 transmits a predetermined projection image data 230a to the image projector 170.

In the case where the captured article corresponds to one of the articles registered in the POS data storage section 115, the illumination control parameter determiner 220 determines the toning level based on e.g. the article category described above with reference to FIG. 5.

In the case where the captured article corresponds to one of the articles registered in the POS data storage section 115, the projection image generator 230 generates e.g. an image including the price or an image indicating that the article is highly recommended. The article is specified in accordance with the number of articles in stock or the sales status.

According to this specific example, the article information and the sales status, for instance, are obtained from the POS article data 115a stored in the POS data storage section 115. Thus, for instance, the article can be shown so as to look delicious, or an image for enhancing sales campaign of articles with slow sales can be projected, based on e.g. the article information and the sales status.

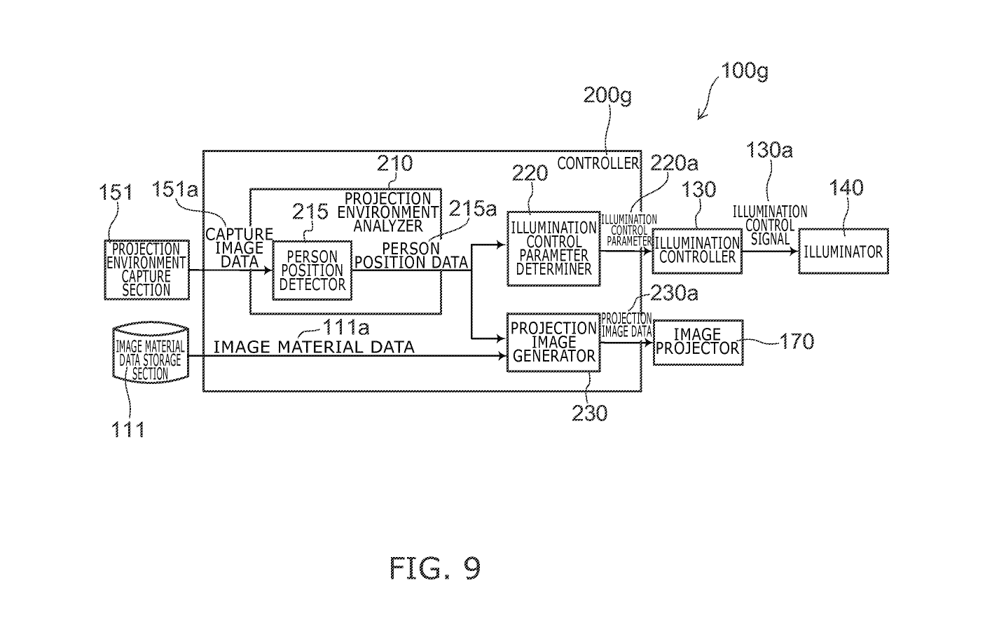

FIG. 9 is a block diagram showing a further alternative specific example of the controller and the image projection system according to this embodiment.

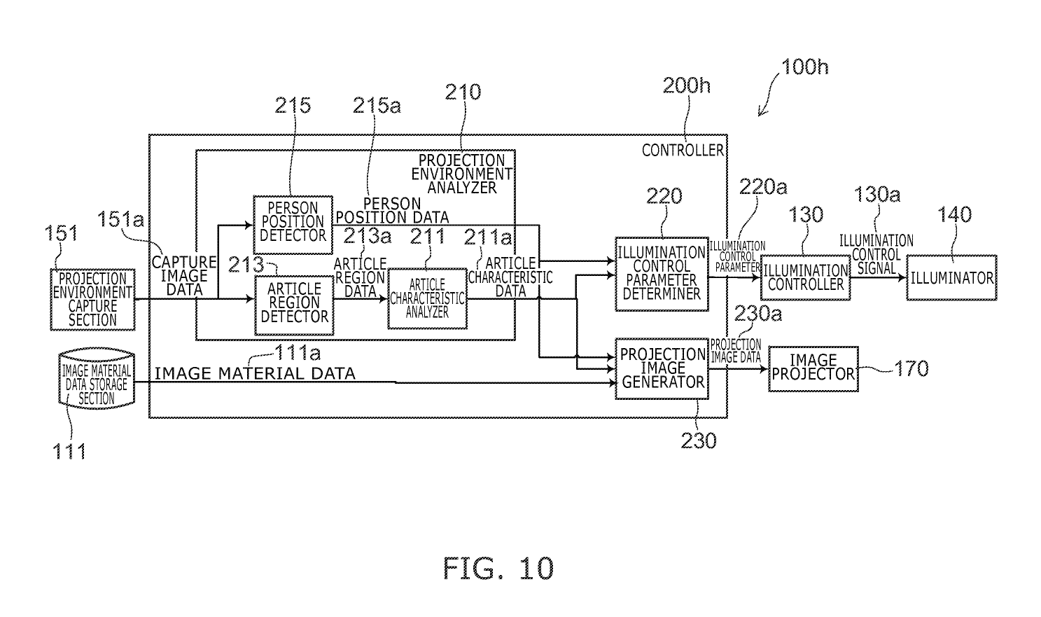

FIG. 10 is a block diagram showing a further alternative specific example of the controller and the image projection system according to this embodiment.

In the following, the specific examples shown in FIGS. 9 to 11 are described with reference to an example in which information is projected on the article region.

In the image projection system 100g according to the specific example shown in FIG. 9, the projection environment analyzer 210 of the controller 200g includes a person position detector (second detector) 215. The person position detector 215 detects the position of a person located around the projection target based on the capture image data 151a transmitted from the projection environment capture section 151. The person position detector 215 transmits the detection result as person position data 215a to the illumination control parameter determiner 220 and the projection image generator 230. The person position detector 215 may detect e.g. the motion of the person, the face of the person, the eye-gaze of the person, or the attribute of the person. The rest of the configuration is as described above with reference to FIG. 2.

As in the image projection system 100h according to the specific example shown in FIG. 10, the projection environment analyzer 210 of the controller 200h may further include an article characteristic analyzer 211 and an article region detector 213. The article characteristic analyzer 211 is as described above with reference to FIG. 3. The article region detector 213 is as described above with reference to FIG. 4. The rest of the configuration is as described above with reference to FIG. 2.

Here, the operation (control method) of the controller 200h and the image projection system 100h of the specific example shown in FIG. 10 is described with reference to the drawings.

FIG. 11 is a flow chart showing the control method of the specific example shown in FIG. 10.

The operation of step S201, step S203, and step S205 is similar to the operation of step S101, step S103, and step S105, respectively, described above with reference to FIG. 5.

The person position detector 215 detects the position of a person located within the capturable range (step S207). For instance, the person position detector 215 detects the position of a person by analyzing the capture image data 151a transmitted from the projection environment capture section 151. The detection of the position of a person is based on e.g. existing pattern matching and learning techniques.

Next, the illumination control parameter determiner 220 sets the toning level to an initial value (step S209). The operation of step S209 is similar to the operation of step S107 described above with reference to FIG. 5. Next, the illumination control parameter determiner 220 determines whether a person has been detected based on the person position data 215a transmitted from the person position detector 215 (step S211). In the case where a person has been detected (step S211: yes), the illumination control parameter determiner 220 determines whether there is an article region (step S213). On the other hand, in the case where no person has been detected (step S211: no), the illumination control parameter determiner 220 determines the dimming level to be a first dimming level without changing the toning level (step S221).

Next, in the case where there is an article region (step S213: yes), the illumination control parameter determiner 220 determines a toning level (step S215). The toning level is determined based on the article characteristic data 211a. In the case where there is no article region (step S213: no), the illumination control parameter determiner 220 determines whether the value of the non-article region is T or more without changing the toning level (step S219).

The operation of step S219, step S221, step S223, and step S225 is similar to the operation of step S113, step S115, step S117, and step S119, respectively, described above with reference to FIG. 5.

The projection image generator 230 generates a projection image with all the pixels set to black (step S227). The operation of step S227 is similar to the operation of step S121 described above with reference to FIG. 5.

Next, the projection image generator 230 determines whether a person has been detected based on the person position data 215a transmitted from the person position detector 215 (step S231). In the case where a person has been detected (step S229: yes), the projection image generator 230 determines whether the value of the non-article region is T or more (step S231).

On the other hand, in the case where no person has been detected (step S229: no), the projection image generator 230 acquires second image material data from the image material data storage section 111 (step S237). The case where no person has been detected means that no person is located near the store shelf. Thus, it is more preferable that the second image material data include e.g. an image attracting the attention of a person located at a position far from the store shelf.

Next, the projection image generator 230 updates the entirety of the projection image based on the second image material data acquired from the image material data storage section 111 (step S239). For instance, the projection image generator 230 expands the second image material data acquired from the image material data storage section 111 into the maximum size displayable on the projection surface. Next, the projection image generator 230 updates the entirety of the projection image by overwriting the projection image with the information of the expanded image. Existing methods are used in expanding the image.

Here, calibration between the position of the image projected by the image projector 170 and the position of the image captured by the projection environment capture section 151 is performed in advance by existing methods.

The projection image generator 230 may estimate color information of the projection surface (such as projection surface reflectance for each pixel) based on the capture image data 151a transmitted from the projection environment capture section 151. Thus, the projection image generator 230 may generate an image with the color and brightness corrected so that the color and brightness of the projected image are made close to the original color and brightness of the image material data.

The operation of step S231, step S233, step S235, and step S241 is similar to the operation of step S123, step S125, step S127, and step S129, respectively, described above with reference to FIG. 5.

According to this specific example, in the case where a person is located around the projection target, prevention of purchase action by illumination light illuminating the article can be suppressed. In the case where a person is located at a position far from the store shelf, the person's attention can be attracted to the store shelf by projecting the image on the entirety of the projection surface including the article region.

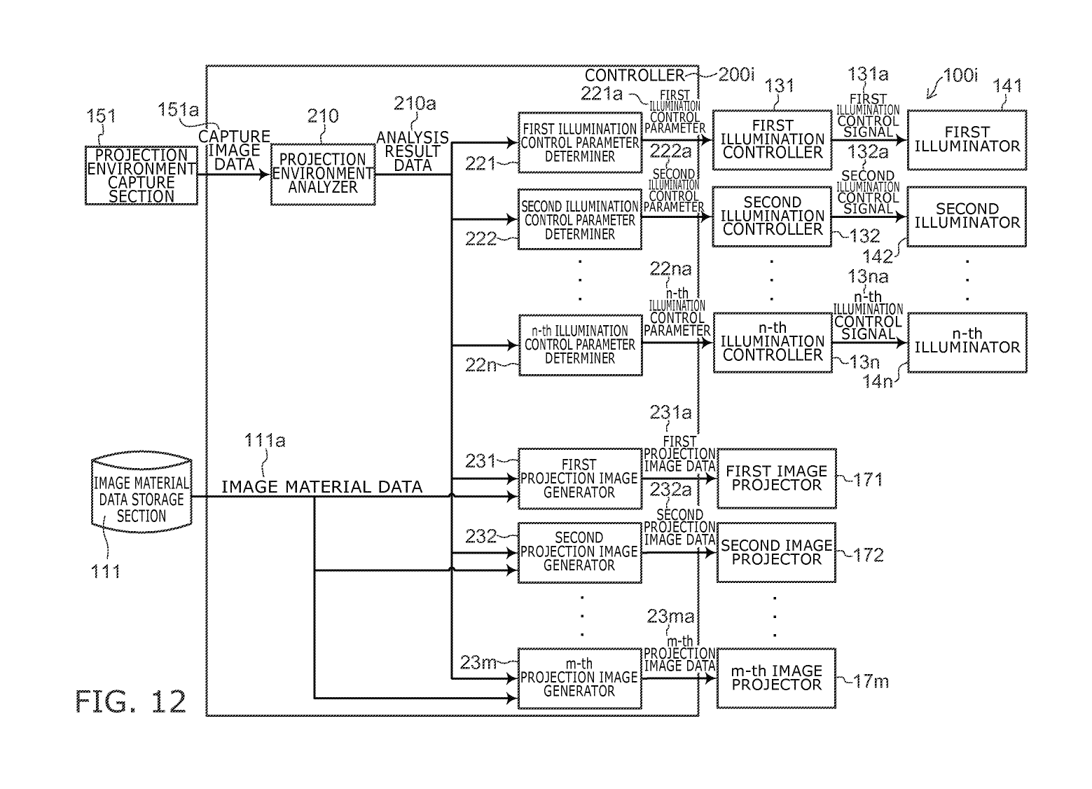

FIG. 12 is a block diagram showing a further alternative specific example of the controller and the image projection system according to this embodiment.

In the image projection system 100i according to the specific example shown in FIG. 12, the controller 200i includes a plurality of illumination control parameter determiners. For instance, the controller 200i includes a first illumination control parameter determiner 221, a second illumination control parameter determiner 222, . . . , and an n-th illumination control parameter determiner 22n.

The controller 200i includes a plurality of projection image generators. For instance, the controller 200i of this specific example includes a first projection image generator 231, a second projection image generator 232, . . . , and an m-th projection image generator 23m.

The image projection system 100i of this specific example includes a plurality of illumination controller s. For instance, the image projection system 100i includes a first illumination controller 131, a second illumination controller 132, . . . , and an n-th illumination controller 13n.

The image projection system 100i of this specific example includes a plurality of illuminators. For instance, the image projection system 100i includes a first illuminator 141, a second illuminator 142, . . . , and an n-th illuminator 14n.

The image projection system 100i of this specific example includes a plurality of image projectors. For instance, the image projection system 100i includes a first image projector 171, a second image projector 172, . . . , and an m-th image projector 17m.

The rest of the configuration is as described above with reference to FIG. 2.

The first illumination control parameter determiner 221 determines a first illumination control parameter 221a based on the analysis result data 210a transmitted from the projection environment analyzer 210. The first illumination control parameter 221a is a parameter for controlling the first illuminator 141. The first illumination control parameter determiner 221 transmits the first illumination control parameter 221a to the first illumination controller 131. The second illumination control parameter determiner 222 determines a second illumination control parameter 222a based on the analysis result data 210a transmitted from the projection environment analyzer 210. The second illumination control parameter 222a is a parameter for controlling the second illuminator 142. The second illumination control parameter determiner 222 transmits the second illumination control parameter 222a to the second illumination controller 132.

The first projection image generator 231 generates an image projected from the first image projector 171. This is based on the analysis result data 210a transmitted from the projection environment analyzer 210 and the image material data 111a acquired from the image material data storage section 111. The first projection image generator 231 transmits the first projection image data 231a to the first image projector 171. The second projection image generator 232 generates an image projected from the second image projector 172. This is based on the analysis result data 210a transmitted from the projection environment analyzer 210 and the image material data 111a acquired from the image material data storage section 111. The second projection image generator 232 transmits the second projection image data 232a to the second image projector 172.

The first illumination controller 131 transmits a first illumination control signal 131a to the first illuminator 141. The first illumination control signal 131a is a signal for controlling the first illuminator 141 based on the first illumination control parameter 221a transmitted from the first illumination control parameter determiner 221. The second illumination controller 132 transmits a second illumination control signal 132a to the second illuminator 142. The second illumination control signal 132a is a signal for controlling the second illuminator 142 based on the second illumination control parameter 222a transmitted from the second illumination control parameter determiner 222.

The first illuminator 141 emits illumination light having a dimming level and a toning level based on the first illumination control signal 131a transmitted from the first illumination controller 131. The second illuminator 142 emits illumination light having a dimming level and a toning level based on the second illumination control signal 132a transmitted from the second illumination controller 132.

According to this specific example, generation of the projection image and determination of the illumination control parameter can be performed in view of the influence of the illuminator around the projection target and the projector around the projection target. Furthermore, this specific example can be adapted to the environment of the store provided with a plurality of illuminators and a plurality of image projectors. In other words, a plurality of illuminators and a plurality of image projectors can be controlled by one controller 200i.

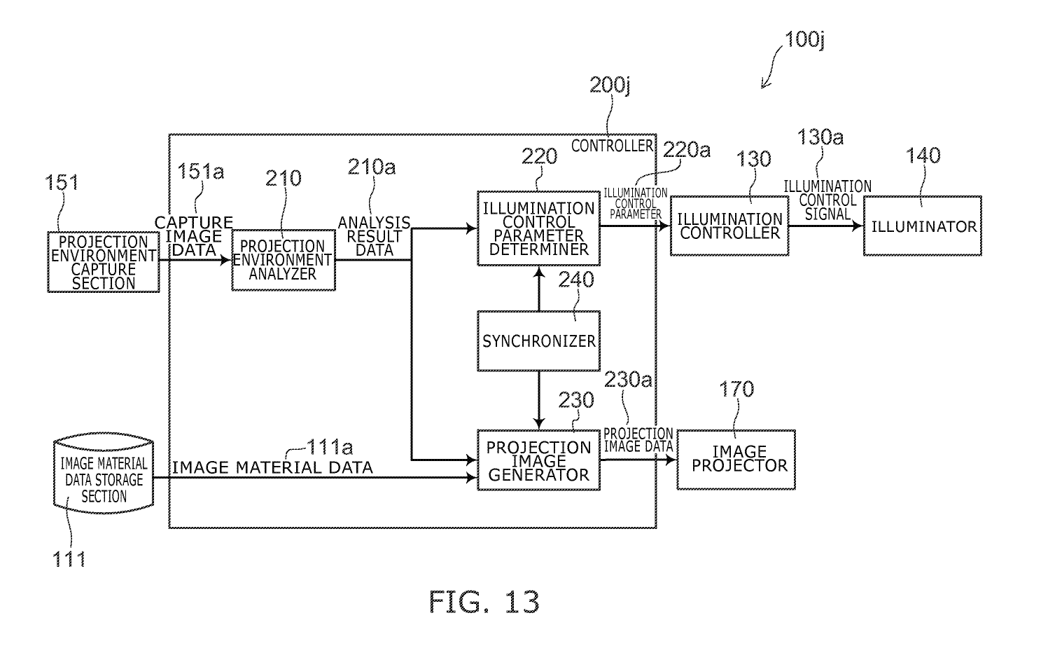

FIG. 13 is a block diagram showing a further alternative specific example of the controller and the image projection system according to this embodiment.

In the image projection system 100j according to the specific example shown in FIG. 13, in comparison with the image projection system 100a according to the specific example described above with reference to FIG. 2, the controller 200j further includes a synchronizer 240. The illumination control parameter determiner 220 determines an illumination control parameter 220a. The illumination control parameter determiner 220 transmits the illumination control parameter 220a to the illumination controller 130 at a timing. On the other hand, the projection image generator 230 generates a projection image. The projection image generator 230 transmits the projection image data 230a to the image projector 170 at a timing. The synchronizer 240 synchronizes these timings with each other.

This specific example is useful in the case where the articles are dynamically interchanged, or the store display is changed momentarily. For instance, at least one of the image and the illumination light may be dynamically changed in response to the person. In this case, an arbitrary image and arbitrary illumination light can be synchronized with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller comprising:
an analyzer which analyzes an environment of a projection surface on which an image is projected, based on a capture image obtained by capturing a region including at least part of the projection surface;
a determiner which determines a parameter for controlling illumination light illuminating the region based on information regarding the analyzed environment; and
a projection image generator which generates a projection image projected on the region based on the information regarding the environment and acquired image data.

2. The controller according to claim 1, wherein
the analyzer analyzes characteristic of an object article included in the projection surface based on the capture image,
the determiner determines the parameter based on the characteristic, and
the projection image generator generates the projection image based on the characteristic.

3. The controller according to claim 2, wherein the characteristic includes information regarding at least one of color of the object article, temperature of the object article, freshness of the object article, and surface profile of the object article.

4. The controller according to claim 1, wherein
the analyzer includes a first detector which detects a region of an object article based on the capture image,
the determiner determines the parameter based on the region of the object article, and
the projection image generator generates the projection image based on the region of the object article.

5. The controller according to claim 1, wherein the projection image generator generates the projection image based on the parameter.

6. The controller according to claim 1, wherein
the analyzer includes a second detector which detects position of a person around the projection surface based on the projection image,
the determiner determines the parameter based on the position, and
the projection image generator generates the projection image based on the position.

7. The controller according to claim 1, wherein
the determiner determines the parameter based on time schedule data on a time schedule management system, and
the projection image generator generates the projection image based on the time schedule data.

8. The controller according to claim 2, wherein
the analyzer analyzes which of object article data on a POS system corresponds to the object article,
the determiner determines the parameter based on a result of the analysis, and
the projection image generator generates the projection image based on the result of the analysis.

9. The controller according to claim 1, wherein
the determiner is provided in a plurality,
the projection image generator is provided in a plurality,
each of the plurality of the determiners determines the parameter based on information regarding the environment, and
each of the plurality of the projection image generators generates the projection image based on the information regarding the environment.

10. A control method comprising:
analyzing an environment of a projection surface on which an image is projected, based on a capture image obtained by capturing a region including at least part of the projection surface;
determining a parameter for controlling illumination light illuminating the region based on information regarding the analyzed environment; and
generating a projection image projected on the region based on the information regarding the environment and acquired image data.

11. The method according to claim 10, wherein
characteristic of an object article included in the projection surface is analyzed based on the capture image,
the parameter is determined based on the characteristic, and
the projection image is generated based on the characteristic.

12. The method according to claim 10, wherein
a region of an object article is detected based on the capture image,
the parameter is determined based on the region of the object article, and
the projection image is generated based on the region of the object article.

13. The method according to claim 10, wherein
position of a person around the projection surface is detected based on the projection image,
the parameter is determined based on the position, and
the projection image is generated based on the position.

14. An image projection system comprising:
a computer;
a capture device connected to the computer and which captures a region including at least part of a projection surface on which an image is projected;
an illuminator connected to the computer and which emits illumination light based on a parameter; and
an image projector connected to the computer and which projects a projection image on the projection surface,
the computer having:
a function of analyzing an environment of the projection surface based on a capture image captured by the capture device;
a function of determining the parameter for controlling the illumination light illuminating the region based on information regarding the analyzed environment; and
a function of generating a projection image projected on the region based on the information regarding the environment and image data.

15. The system according to claim 14, wherein
the analyzer analyzes characteristic of an object article included in the projection surface based on the capture image,
the determiner determines the parameter based on the characteristic, and
the projection image generator generates the projection image based on the characteristic.

16. The system according to claim 14, wherein
the analyzer includes a first detector which detect a region of an object article based on the capture image,
the determiner determines the parameter based on the region of the object article, and
the projection image generator generates the projection image based on the region of the object article.

17. The system according to claim 14, wherein
the analyzer includes a second detector which detects position of a person around the projection surface based on the projection image,
the determiner determines the parameter based on the position, and
the projection image generator generates the projection image based on the position.

18. An image processor comprising:
a controller; and
an illuminator connected to the controller and which emits illumination light based on a parameter,
the controller having:
an analyzer which analyzes an environment of a projection surface on which an image is projected, based on a capture image obtained by capturing a region including at least part of the projection surface;
a determiner which determines the parameter for controlling illumination light illuminating the region based on information regarding the analyzed environment; and
a projection image generator which generates a projection image projected on the region based on the information regarding the environment and acquired image data.
